(19) United States
(12) Patent Application Publication
(10) Pub. No.: US 2014/0340261 A1
(43) Pub. Date: Nov. 20, 2014

(54) DUAL BAND ANTENNA

(71) Applicant: NVIDIA Corporation, Santa Clara, CA (US)

(72) Inventor: Mehdi M. Mechaik, Austin, TX (US)

(73) Assignee: NVIDIA Corporation, Santa Clara, CA (US)

(21) Appl. No.: 13/894,580

(22) Filed: May 15, 2013

(51) Int. Cl. H01Q 5/01

(52) U.S. Cl. CPC H01Q 5/01
USPC 343/700 MS

(57) ABSTRACT

Provided is a dual band antenna. The dual band antenna, in this aspect, includes an active element, the active element having a first resonant portion operable to effect a first antenna for communication in a first band of frequencies, and a second resonant portion operable to effect a second antenna for communication in a second different band of frequencies. The dual band antenna, of this aspect, further includes a ground element. In this aspect, the ground element and active element are structurally equivalent or functionally equivalent.

### TECHNICAL FIELD

This application is directed, in general, to antennas and, more specifically, to antennas for electronic devices.

### BACKGROUND

Electronic devices are becoming increasingly popular. Examples of electronic devices include handheld computers, cellular telephones, media players, gaming consoles, remote controls, modems, routers, etc., as well as hybrid devices that include the functionality of multiple devices of this type.

Due in part to their mobile nature, electronic devices are often provided with wireless communications capabilities. Electronic devices may use long-range wireless communications to communicate with wireless base stations. For example, cellular telephones may communicate using 2G Global System for Mobile Communication (commonly referred to as GSM) frequency bands at about 850 MHz, 900 MHz, 1800 MHz, and 1900 MHz, among possible others. Communication is also possible in the 3G Universal Mobile Telecommunication System (commonly referred to as UMTS) and 4G Long Term Evolution (commonly referred to as LTE) frequency bands which range from 700 MHz to 3800 MHz. Furthermore, communication can operate on channels with variable bandwidths of 1.4 MHz to 20 MHz for LTE, as opposed to the fixed bandwidths of GSM (0.2 MHz) and UMTS (5 MHz). Electronic devices may also use short-range wireless communications links. For example, electronic devices may communicate using the Wi-Fi® (IEEE 802.11) bands at about 2.4 GHz and 5 GHz, and the Bluetooth® band at about 2.4 GHz. Electronic devices with Global Positioning System (GPS) capabilities receive GPS signals at about 1575 MHz.

To satisfy consumer demand for small form factor wireless devices, manufacturers are continually striving to reduce the size of components that are used in these devices. For example, manufacturers have made attempts to miniaturize the antennas used in electronic devices. Unfortunately, doing so within the confines of the wireless device package is challenging.

Accordingly, what is needed in the art is an antenna, and associated wireless electronic device that navigates the desires and problems associated with the foregoing.

### SUMMARY

Provided, in one aspect, is a dual band antenna. The dual band antenna, in this aspect, includes an active element, the active element having a first resonant portion operable to effect a first antenna for communication in a first band of frequencies, and a second resonant portion operable to effect a second antenna for communication in a second different band of frequencies. The dual band antenna, of this aspect, further includes a ground element. In this aspect, the ground element and active element are structurally equivalent or functionally equivalent.

Provided in another aspect is an alternative dual band antenna. The alternative dual band antenna, in this aspect, includes an active element and a ground element. The active element, in this aspect, includes a first resonant portion operable to effect a first antenna for communication in a Bluetooth® band ranging from about 2.4 GHz to about 2.483 GHz, and a second resonant portion operable to effect a second antenna for communication in a Wi-Fi® band ranging from about 4.5 GHz to about 6.5 GHz. In this alternative aspect, a voltage-standing wave-ratio (VSWR) value is less than about 2.0 over the entire Bluetooth® band ranging from about 2.4 GHz to about 2.483 GHz.

Additionally provided is an electronic device. The electronic device, in this aspect, includes: 1) storage and processing circuitry, 2) input-output devices associated with the storage and processing circuitry, and 3) wireless communications circuitry including a dual band antenna. The dual band antenna, in this aspect, includes an active element having a first resonant portion operable to effect a first antenna for communication in a first band of frequencies, and a second resonant portion operable to effect a second antenna for communication in a second different band of frequencies. The dual band antenna, in this aspect, further includes a ground element, wherein the ground element and active element are structurally equivalent or functionally equivalent.

### BRIEF DESCRIPTION

Reference is now made to the following descriptions taken in conjunction with the accompanying drawings, in which:

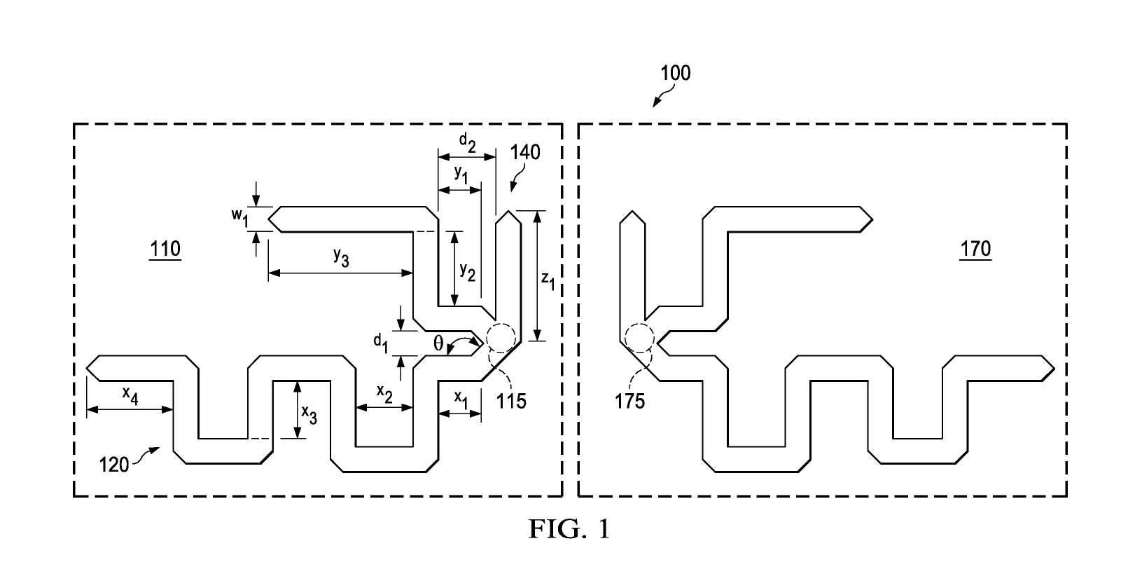

FIG. 1 illustrates aspects of a representative embodiment of a dual band antenna in accordance with embodiments of the disclosure;

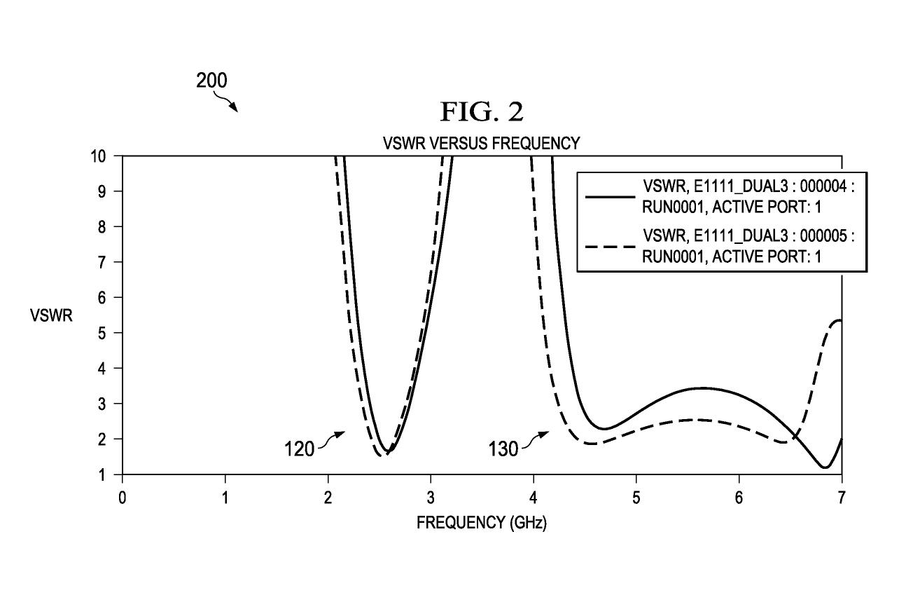

FIG. 2 illustrates a VSWR plot of the specific embodiment disclosed with regard to FIG. 1;

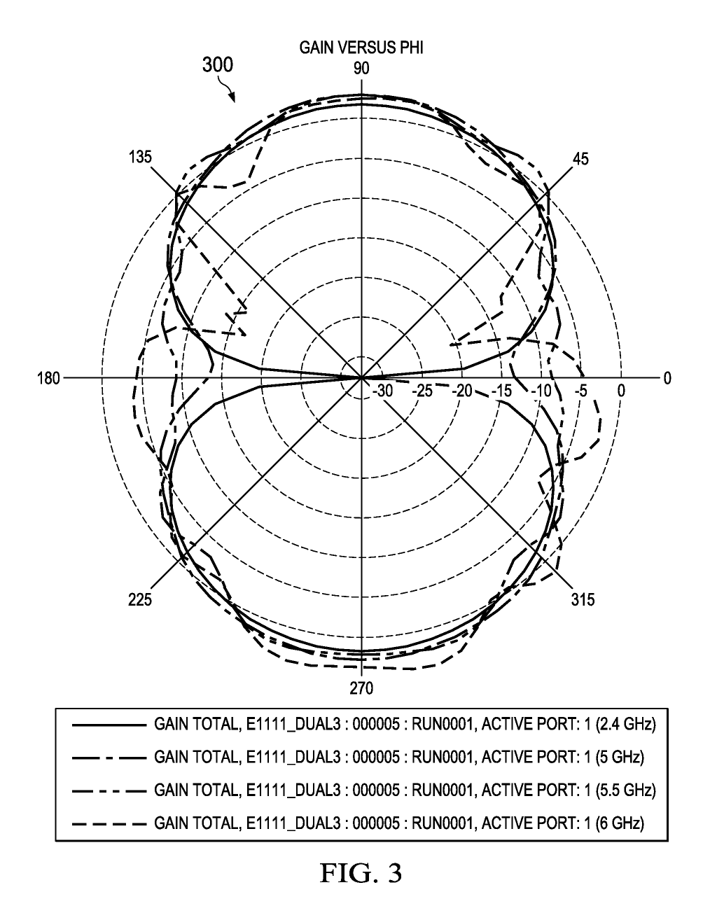

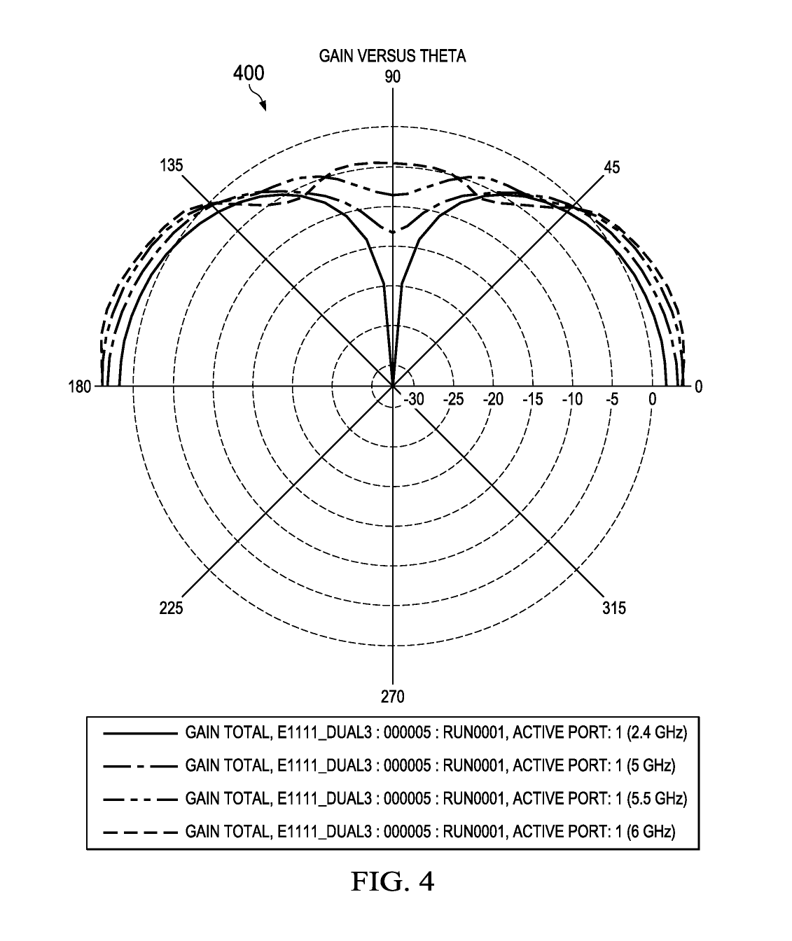

FIGS. 3 and 4 illustrate 2-dimensional radiation patterns that may be obtained for a dual band antenna such as the antenna illustrated in FIG. 1; and

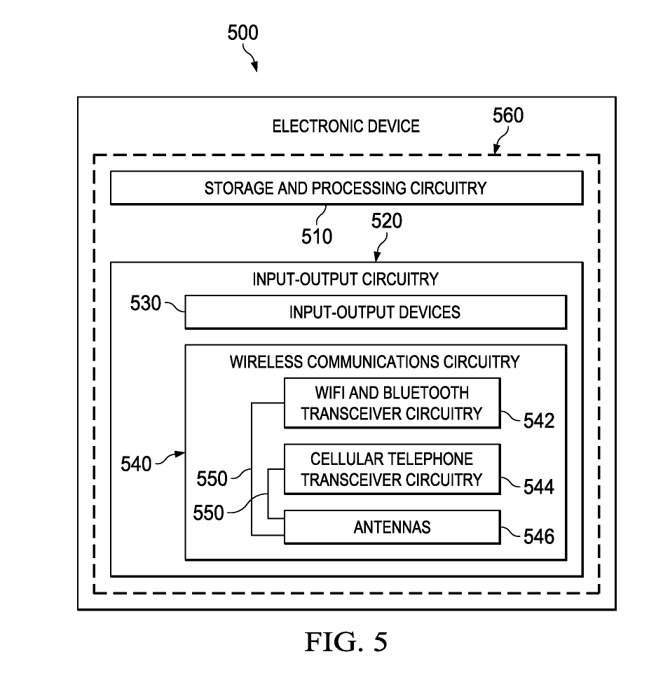

FIG. 5 illustrates a schematic diagram of electronic device in accordance with the disclosure.

### DETAILED DESCRIPTION

The present disclosure is based, at least in part, on the recognition that high quality dual band antennas can be manufactured having extremely low voltage-standing wave-ratio (VSWR) values over the frequencies that the dual band antennas are configured to operate. For the purposes of the present disclosure, a VSWR value is the ratio of the amplitude of a partial standing wave at an antinode (maximum) to the amplitude at an adjacent node (minimum) for the antenna structure. VSWR values are a useful measure of how efficient an antenna system is. A VSWR value of unity is an ideal case that is rarely (if ever) achieved, but values of less than 5 are indicative of a well-designed and efficient antenna.

With the foregoing said, the present disclosure has recognized that heretofore unattainable VSWR values for a Bluetooth® band ranging from about 2.4 GHz to about 2.483 GHz and a Wi-Fi® band ranging from about 4.5 GHz to about 6.5 GHz may be achieved in a single antenna structure. For example, the Bluetooth® band ranging from about 2.4 GHz to about 2.483 GHz may achieve a VSWR value of less than about 2.0 over the entire Bluetooth® band. Likewise, the Wi-Fi® band ranging from about 4.5 GHz to about 6.5 GHz may achieve a VSWR value of less than about 3.0, or even 2.75, over the entire Wi-Fi® band.

The present disclosure has further recognized that the dual band antennas may include an active element and a ground element. In accordance with one embodiment of the disclosure, the ground element and active element are structurally equivalent or functionally equivalent. In certain other embodiments, the ground element and active element are symmetric. A ground element is structurally equivalent to the active element when the area of the ground element is within 10% of the area of the active element or lengths and widths of all segments of the ground element are within 20% of corresponding lengths and widths of corresponding segments of the active element. A ground element is functionally equivalent to the active element when the VSWR of the ground element is within 10% of the VSWR of the active element. In accordance with another embodiment of the disclosure, the ground element and active element are strongly structurally equivalent or strongly functionally equivalent. A ground element is strongly structurally equivalent to the active element when the area of the ground element is within 5% of the area of the active element or lengths and widths of all segments of the ground element are within 10% of corresponding lengths and widths of corresponding segments of the active element. A ground element is strongly functionally equivalent to the active element when the VSWR of the ground element is within 5% of the VSWR of the active element. In yet another embodiment of the disclosure, the ground element and active element are tightly structurally equivalent or tightly functionally equivalent. A ground element is tightly structurally equivalent to the active element when the area of the ground element is within 1% of the area of the active element or lengths and widths of all segments of the ground element are within 5% of corresponding lengths and widths of corresponding segments of the active element. A ground element is tightly functionally equivalent to the active element when the VSWR of the ground element is within 2% of the VSWR of the active element. In one embodiment, when the active element and ground element are implemented as two arms of an antenna, they provide a function and its complement thereby making the whole.

The structural equivalence and functional equivalence, in one embodiment, may be achieved by having the active element and ground element being symmetric images of one another. The structural equivalence and functional equivalence, in another embodiment, may be achieved by having the active element and ground element being mirror images of one another. Moreover, because of the structural and functional equivalence, the ground element can be driven by a signal to be transmitted and the active element can reflect the signal to be transmitted, and thus the ground element functions as a modified active element and the active element functions as a modified ground element. Accordingly, in operation of this embodiment, both elements are interchangeable and it does not matter whether the active element and ground element swap functions. Accordingly, one acts as the source (e.g., giving out current) and the other acts as the sink (e.g., absorbing current), or vice-versa.

The present disclosure has further recognized that such a single antenna structure can be formed on a printed circuit board. In one embodiment, the antenna can be manufactured from readily available copper or aluminum materials, among others. Accordingly, the manufacture of such an antenna would be relatively inexpensive and easy—as compared to a chip antenna having active silicon circuitry.

Moreover, the present disclosure has recognized that such an antenna operates better without a large ground plane located thereover or thereunder. Both of the aforementioned recognitions can save tremendous amounts of “real estate” in the electronic device the dual band antenna is employed within. Accordingly, a dual band antenna manufactured in accordance with the disclosure may lend itself to smaller electronic device packaging.

FIG. 1 illustrates aspects of a representative embodiment of a dual band antenna 100 in accordance with embodiments of the disclosure. The dual band antenna 100 of FIG. 1 includes an active element 110 and a ground element 170. The active element 110, in this embodiment, may be that portion of the dual band antenna 100 operable to first receive radio frequency signals (e.g., a signal to be transmitted) from one or more associated transceivers in a related electronic device. For example, the active element 110 might directly couple (e.g., through connection point 115) to a positive terminal of a transmission line (not shown), such as a coaxial cable, microstrip, etc., to receive radio frequency signals from associated transceivers, and provide them to the other portions of the dual band antenna 100. The active element 110 may additionally receive radio frequency signals, and thus provide them to the associated transceivers. In the illustrated embodiment, ground element 170 might directly couple (e.g., through connection point 175) to a negative terminal of the transmission line (not shown), such as a coaxial cable, microstrip, etc. Accordingly, the ground element 170 may be operable to reflect the signal to be transmitted by the active element 110.

In accordance with one embodiment of the disclosure, the active element 110 and the ground element 170 are structurally equivalent or functionally equivalent. In alternative embodiments, the active element 110 and the ground element 170 are structurally equivalent but not functionally equivalent, or functionally equivalent but not structurally equivalent, or alternatively structurally equivalent and functionally equivalent. In yet alternative embodiments, the active element 110 and the ground element 170 are strongly structurally equivalent or strongly functionally equivalent, or strongly structurally equivalent but not strongly functionally equivalent, or strongly functionally equivalent but not strongly structurally equivalent, or alternatively strongly structurally equivalent and strongly functionally equivalent. In yet other embodiments, the active element 110 and the ground element 170 are tightly structurally equivalent or tightly functionally equivalent, or tightly structurally equivalent but not tightly functionally equivalent, or tightly functionally equivalent but not tightly structurally equivalent, or alternatively tightly structurally equivalent and tightly functionally equivalent. In another embodiment, any combination of structurally equivalent, strongly structurally equivalent, tightly structurally equivalent, functionally equivalent, strongly functionally equivalent, and tightly functionally equivalent might be used, so long as the ground element and active element are at least structurally equivalent or functionally equivalent.

In the embodiment of FIG. 1, the active element 110 and the ground element 170 are mirror images of one another. The mirror image nature of the active element 110 and the ground element 170 is one feature that might cause the active element 110 and ground element 170 to be structurally equivalent or functionally equivalent. Nevertheless, other active and ground elements 110, 170 that are not mirror images of one another can be structurally equivalent or functionally equivalent.

The active element 110 of FIG. 1 includes a first resonant portion 120 operable to effect a first antenna for communication in a first band of frequencies, and a second resonant portion 130 operable to effect a second antenna for communication in a second different band of frequencies. The first band of frequencies, in the illustrated embodiment of FIG. 1, is a Bluetooth® band ranging from about 2.4 GHz to about 2.483 GHz. The second band of frequencies, in the illustrated embodiment of FIG. 1, is a Wi-Fi® band ranging from about 4.5 GHz to about 6.5 GHz. Other different band or frequencies, nevertheless, are within the scope of the present disclosure.

The first resonant portion 120 in the embodiment of FIG. 1 is serpentine in shape. For example, in the embodiment of FIG. 1, the serpentine shape is substantially consistent (e.g., each of the corresponding segments of the serpentine shape are substantially similar). In one embodiment, the first resonant portion 120 has an x₁ value ranging from about 0.5 mm to about 1.5 mm, an x₂ value ranging from about 1.5 mm to about 2.5 mm, an x₃ value ranging from about 2.0 mm to 3.0 mm, and an x₄ value ranging from about 4.5 mm to 5.5 mm. In another specific embodiment, the first resonant portion 120 has an x₁ value of about 1.0 mm, an x₂ value of about 2.0 mm, an x₃ value of about 2.5 mm, and an x₄ value of about 5.0 mm. Similarly, the angle θ may range from about 125 degrees to about 145 degrees, among others. In the specific embodiment discussed, the angle θ is about 135 degrees.

The second resonant portion 130, in the embodiment shown, is z-shaped. In one embodiment, the second resonant portion 130 has a y₂ value ranging from about 0.5 mm to about 1.5 mm, a y₂ value ranging from about 1.5 mm to about 2.5 mm, and a y₃ value ranging from about 4.5 mm to 5.5 mm. In the specific embodiment discussed above, the second resonant portion 130 has a y₁ value of about 1.0 mm, a y₂ value of about 2.0 mm, and a y₃ value of about 5.0 mm.

In the embodiment of FIG. 1, the first resonant portion 120 and the second resonant portion 130 are separated from each other by a distance d₁. The distance d₁, in one embodiment, ranges from about 0.5 mm to about 1.5 mm. In the specific embodiment discussed above, the distance d₁ is about 1.0 mm. The separation of the first and second resonant portions 120, 130 by the distance d₁ provides reduced interference between the two.

Likewise, in the embodiment of FIG. 1, the features of the first resonant portion 120 and the second resonant portion 130 have a width of w₁. The width w₁, in one embodiment, ranges from about 0.5 mm to about 1.5 mm. In the specific embodiment discussed above, the width w₁ is about 1.0 mm. Similarly, as the first and second resonant portions 120, 130 in certain embodiments are formed from a printed circuit board, they may have a thickness (not shown) of approximately 0.015 mm, among others. For example, the thickness may range from about 0.01 mm to about 0.02 mm while having minimal effect on antenna performance.

Located proximate the second resonant portion 130 in the embodiment of FIG. 1 is a balun portion 140. The balun portion 140, in the illustrated embodiment, is configured to help balance the impedance of the second resonant portion 130, and thus provide better antenna characteristics. The balun portion 140, in the illustrated embodiment, has a z₁ value ranging from about 4.5 mm to about 5.5 mm. In the specific embodiment discussed above, the z₁ value is about 5.0 mm. In the embodiment illustrated, the balun portion 140 has a similar width w₁ to the first and second resonant portions 120, 130.

An antenna, such as the antenna 100 of FIG. 1, may be configured as a plug-n-play antenna because of its unique design and/or features. Accordingly, the antenna need not be customized for a specific enclosure—as the antenna does not rely upon a ground plane in the enclosure for the operation thereof. Moreover, as indicated above, the unique configuration of the antenna allows for situations wherein the active element and ground element can be swapped, and thus the active element to function as a modified ground element, and the ground element to function as a modified active element.

Turning briefly to FIG. 2, illustrated is a VSWR plot 200 of the specific embodiment disclosed above with regard to FIG. 1. As is illustrated in FIG. 2, the first resonant portion 120 having the Bluetooth® band ranging from about 2.4 GHz to about 2.483 GHz has a voltage-standing wave-ratio (VSWR) value of less than about 2.0. Additionally, the second resonant portion 130 having the Wi-Fi® band ranging from about 4.5 GHz to about 6.5 GHz has a voltage-standing wave-ratio (VSWR) value of less than about 3.0. In fact, as illustrated in FIG. 2, the second resonant portion 130 having the Wi-Fi® band ranging from about 4.5 GHz to about 6.5 GHz has a voltage-standing wave-ratio (VSWR) value of less than about 2.75. FIG. 2 additionally illustrates that there is good isolation between the first resonant portion 120 and the second resonant portion 130. Accordingly, there is limited crosstalk between the two resonant portions 120, 130, even despite their physical proximity.

Turning to FIGS. 3 and 4, illustrated are 2-dimensional radiation patterns 300, 400 that may be obtained for a dual band antenna such as the antenna 100 illustrated in FIG. 1. Specifically, the 2-dimensional radiation patterns 300, 400 are from a dual band antenna similar to the specific embodiment discussed above with regard to FIG. 1. The 2-dimensional radiation pattern 300 of FIG. 3. illustrates the horizontal polarization of the first resonant portion operating in the Bluetooth® band ranging from about 2.4 GHz to about 2.483 GHz, and the second resonant portion operating in the Wi-Fi® band ranging from about 4.5 GHz to about 6.5 GHz. Alternatively, the 2-dimensional radiation pattern 400 of FIG. 4 illustrates the vertical polarization of the first resonant portion operating in the Bluetooth® band ranging from about 2.4 GHz to about 2.483 GHz, and the second resonant portion operating in the Wi-Fi® band ranging from about 4.5 GHz to about 6.5 GHz. The 2-dimensional radiation pattern 300 is a radiation field plot in the plane parallel to the antenna or could be in the plane of the antenna, but that of 400 is a radiation field plot in a plane perpendicular to the plane of the antenna.

As can be seen from FIGS. 3 and 4, the dual band antenna according to the present disclosure is very efficient in all directions around its orientation. This is particularly noticeable across a range of frequencies for Bluetooth® and Wi-Fi®, which shows the broadband effectiveness of the dual band antenna according to this disclosure. Additionally, it is a low power antenna.

FIG. 5 shows a schematic diagram of electronic device 500 in accordance with the disclosure. Electronic device 500 may be a portable device such as a mobile telephone, a mobile telephone with media player capabilities, a handheld computer, a remote control, a game player, a modem, a global positioning system (GPS) device, a laptop computer, a tablet computer, an ultraportable computer, a combination of such devices, or any other suitable portable electronic device.

As shown in FIG. 5, electronic device 500 may include storage and processing circuitry 510. Storage and processing circuitry 510 may include one or more different types of storage such as hard disk drive storage, nonvolatile memory (e.g., flash memory or other electrically-programmable-read-only memory), volatile memory (e.g., static or dynamic random-access-memory), etc. The processing circuitry in the storage and processing circuitry 510 may be used to control the operation of the electronic device 500. Processing circuitry may be based on a processor such as a microprocessor and other suitable integrated circuit. With one suitable arrangement, storage and processing circuitry 510 may be used to run software on device 500, such as internet browsing applications, voice-over-internet-protocol (VOIP) telephone call applications, email applications, media playback applications, operating system functions, etc. Storage and processing circuitry 510 may be used in implementing suitable communications protocols.

Communications protocols that may be implemented using storage and processing circuitry 510 include, without limitation, internet protocols, wireless local area network protocols (e.g., IEEE 802.11 protocols—sometimes referred to as Wi-Fi®), protocols for other short-range wireless communications links such as the Bluetooth® protocol, protocols for handling 3G communications services (e.g., using wide band code division multiple access techniques), 2G cellular telephone communications protocols, etc. Storage and processing circuitry 510 may implement protocols to communicate using 2G cellular telephone bands at 850 MHz, 900 MHz, 1800 MHz, and 1900 MHz (e.g., the main Global System for Mobile Communications or GSM cellular telephone bands) and may implement protocols for handling 3G Universal Mobile Telecommunication System (commonly referred to as UMTS) and 4G Long Term Evolution (commonly referred to as LTE) communications services. The storage and processing circuitry 510 may additionally implement protocols to communicate using GPS bands at about 1575 MHz.

Input-output device circuitry 520 may be used to allow data to be supplied to device 500 and to allow data to be provided from device 500 to external devices. Input-output devices 530 such as touch screens and other user input interfaces are examples of input-output circuitry 520. Input-output devices 530 may also include user input-output devices such as buttons, joysticks, click wheels, scrolling wheels, touch pads, key pads, keyboards, microphones, cameras, etc. A user can control the operation of device 500 by supplying commands through such user input devices. Display and audio devices may be included in devices 530, such as liquid-crystal display (LCD) screens, light-emitting diodes (LEDs), organic light-emitting diodes (OLEDs), and other components that present visual information and status data. Display and audio components in input-output devices 530 may also include audio equipment such as speakers and other devices for creating sound. If desired, input-output devices 530 may contain audio-video interface equipment such as jacks and other connectors for external headphones and monitors.

Wireless communications circuitry 540 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 540 may include radio-frequency transceiver circuits for handling multiple radio-frequency communications bands. For example, circuitry 540 may include transceiver circuitry 542 that handles 2.4 GHz and 5 GHz bands for Wi-Fi® (IEEE 802.11) communications and the 2.4 GHz Bluetooth® communications band. Circuitry 540 may also include cellular telephone transceiver circuitry 544 for handling wireless communications in cellular telephone bands such as the GSM bands at 850 MHz, 900 MHz, 1800 MHz, and 1900 MHz, as well as the UMTS and LTE bands (as examples). Wireless communications circuitry 540 can include circuitry for other short-range and long-range wireless links if desired. For example, wireless communications circuitry 540 may include global positioning system (GPS) receiver equipment, wireless circuitry for receiving radio and television signals, paging circuits, etc. In Wi-Fi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 540 may include antennas 546. Device 500 may be provided with any suitable number of antennas. There may be, for example, one antenna, two antennas, three antennas, or more than three antennas, in device 500. At least one of the antennas 546 in the device 500, in one embodiment, is similar to the antennas illustrated and described with regard to FIGS. 1-4 above. In accordance with that discussed above, the antennas may handle communications over dual communications bands. If desired, a dual band antenna may be used to cover two bands (e.g., 2.4 GHz and 5 GHz). Different types of antennas may be used for different bands and combinations of bands.

Paths 550, such as transmission line paths, may be used to convey radio-frequency signals between transceivers 542 and 544, and antennas 546. Radio-frequency transceivers such as radio-frequency transceivers 542 and 544 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 550 may be used to interconnect the transceiver integrated circuits and other components on the printed circuit board with antenna structures in device 500. Paths 550 may include any suitable conductive pathways over which radio-frequency signals may be conveyed including transmission line path structures such as coaxial cables, microstrip transmission lines, etc.

The device 500 of FIG. 5 further includes a chassis 560. The chassis 500 may be used for mounting/supporting electronic components such as a battery, printed circuit boards containing integrated circuits and other electrical devices, etc. For example, in one embodiment, the chassis 560 positions and supports the storage and processing circuitry 510, and the input-output circuitry 520, including the input-output devices 530 and the wireless communications circuitry 540 (e.g., including the Wi-Fi® and Bluetooth® transceiver circuitry 542, the cellular telephone circuitry 544, and the antennas 546.

The chassis 560, in one embodiment, is a metal chassis. For example, the chassis 560 may be made of various different metals, such as aluminum. Chassis 560 may be machined or cast out of a single piece of material, such as aluminum. Other methods, however, may additionally be used to form the chassis 560. The chassis 560, in accordance with one embodiment of the disclosure, should not provide a ground plane above or below the antennas 546. In one embodiment, an internal housing or enclosure (e.g., one made of a Polyimide material in one embodiment) is located within the chassis 560 to separate any metal of the chassis 560 from interfering with the antennas 546.

Those skilled in the art to which this application relates will appreciate that other and further additions, deletions, substitutions and modifications may be made to the described embodiments.

What is claimed is:

1. A dual band antenna, comprising:
an active element, including;
a first resonant portion operable to effect a first antenna for communication in a first band of frequencies; and
a second resonant portion operable to effect a second antenna for communication in a second different band of frequencies; and
a ground element, wherein the ground element and active element are structurally equivalent or functionally equivalent.

2. The dual band antenna of claim 1, wherein the active element is operable to be driven by a signal to be transmitted and the ground element is operable to reflect the signal to be transmitted by the active element.

3. The dual band antenna of claim 1, wherein the first band of frequencies is a Bluetooth® band ranging from about 2.4 GHz to about 2.483 GHz, and the second band of frequencies is a Wi-Fi® band ranging from about 4.5 GHz to about 6.5 GHz.

4. The dual band antenna of claim 3, wherein the Bluetooth® band ranging from about 2.4 GHz to about 2.483 GHz has a voltage-standing wave-ratio (VSWR) value of less than about 2.0.

5. The dual band antenna of claim 3, wherein the Wi-Fi® band ranging from about 4.5 GHz to about 6.5 GHz has a voltage-standing wave-ratio (VSWR) value of less than about 3.0.

6. The dual band antenna of claim 3, wherein the Wi-Fi® band ranging from about 4.5 GHz to about 6.5 GHz has a voltage-standing wave-ratio (VSWR) value of less than about 2.75.

7. The dual band antenna of claim 3, wherein the first resonant portion is serpentine in shape.

8. The dual band antenna of claim 1, wherein the ground element and active element are strongly structural equivalent or strongly functionally equivalent.

9. The dual band antenna of claim 1, wherein the ground element and active element are tightly structural equivalent or tightly functionally equivalent.

10. The dual band antenna of claim 1, wherein the ground element and active element are mirror images of one another.

11. The dual band antenna of claim 10, wherein the ground element can be driven by a signal to be transmitted and the active element can reflect the signal to be transmitted, and thus the ground element function as a modified active element and the active element function as a modified ground element.

12. The dual band antenna of claim 1, wherein the active element and ground element are elements on a printed circuit board.

13. The dual band antenna of claim 12, wherein a ground plane is not located above or below the active element or ground element.

14. A dual band antenna, comprising:
an active element, including;
a first resonant portion operable to effect a first antenna for communication in a Bluetooth® band ranging from about 2.4 GHz to about 2.483 GHz, wherein a voltage-standing wave-ratio (VSWR) value is less than about 2.0 over the entire Bluetooth® band ranging from about 2.4 GHz to about 2.483 GHz; and
a second resonant portion operable to effect a second antenna for communication in a Wi-Fi® band ranging from about 4.5 GHz to about 6.5 GHz; and
a ground element.

15. The dual band antenna of claim 14, wherein a voltage-standing wave-ratio (VSWR) value is less than about 3.0 over the entire Wi-Fi® band ranging from about 4.5 GHz to about 6.5 GHz.

16. The dual band antenna of claim 14, wherein the ground element and active element are mirror images of one another.

17. The dual band antenna of claim 14, wherein the active element and ground element are elements on a printed circuit board.

18. The dual band antenna of claim 17, wherein a ground plane is not located above or below the active element or ground element.

19. An electronic device, comprising:
storage and processing circuitry;
input-output devices associated with the storage and processing circuitry; and
wireless communications circuitry including a dual band antenna, the dual band antenna including;
an active element, including;
a first resonant portion operable to effect a first antenna for communication in a first band of frequencies; and
a second resonant portion operable to effect a second antenna for communication in a second different band of frequencies; and
a ground element, wherein the ground element and active element are structurally equivalent or functionally equivalent.

20. The electronic device of claim 19, wherein the first band of frequencies is a Bluetooth® band ranging from about 2.4 GHz to about 2.483 GHz, and the second band of frequencies is a Wi-Fi® band ranging from about 4.5 GHz to about 6.5 GHz.
